(19) United States
(12) Patent Application Publication
(10) Pub. No.: US 2016/0207245 A1
(43) Pub. Date: Jul. 21, 2016

(54) DEVICE AND METHOD FOR PRODUCING STERILE CONTAINERS

(71) Applicant: KHS CORPOPLAST GMBH, Hamburg (DE)

(72) Inventors: Frank LEWIN, Tangstedt (DE); Thomas HEROLD, Ahrensburg (DE); Jan Fabian MEYER, Hamburg (DE); Martin GERHARDS, Hamburg (DE); Dieter KLATT, Hamburg (DE); Rolf BAUMGARTE, Ahrensburg (DE)

(21) Appl. No.: 14/911,660

(22) PCT Filed: Aug. 12, 2014
(86) PCT No.: PCT/EP2014/002206

§ 371 Date: Apr. 4, 2016

(30) Foreign Application Priority Data
Aug. 19, 2013 (DE) 10 2013 013 592.3

(51) Int. Cl. B29C 49/42; B29C 49/68

(52) U.S. Cl. CPC B29C 49/4252; B29C 49/68; B29C 49/4205; B29K 2067/003

(57) ABSTRACT

A method and a device for producing blow-molded containers, which are sterile at least in some areas, in a blow-molding machine. A preform made of a thermoplastic material is first guided through a heating device by a supporting device, heated in the heating device, and then supplied with a pressurized fluid, and the preform is supplied with a sterilizing radiation at least in some areas. At least one radiation source for the sterilizing radiation is arranged in the heating device in a stationary manner at a distance to the preform, and the radiation direction of at least one of the at least one radiation sources is oriented towards the opening region of the preform and/or towards the supporting device.

The invention relates to a method for producing in a blowing machine blow-molded containers which are sterile in at least some areas, in which method a preform from a thermoplastic material by means of a carrier installation is initially guided through a heating installation and heated in the heating installation, and then is impinged with a pressurized fluid, and in which method the preform is impinged with sterilizing radiation at least in some areas.

The invention moreover relates to a blowing machine for producing blow-molded containers which are sterile in at least some areas, which blowing machine has a sterilizing installation having at least one radiation source for impinging at least part of a preform with sterilizing radiation, and which is provided with a heating installation for temperature controlling the preforms at a blow-molding temperature and with a blowing installation for blow-molding the preforms to form the containers, wherein carrier installations guide the preforms through the heating installation. Further aspects of the invention relate to a heating installation and to a heating box.

Manufacturing of sterile blow-molded containers is typically performed in such a manner that these containers after blow-molding and prior to filling are sterilized using hydrogen peroxide or other chemicals. It is likewise already known for the preforms, in particular the area of the internal and of the external surface of these preforms, which in blow-molding of the containers are used as the primary product, to be sterilized by means of radiation.

In the case of container molding by way of the effect of blowing pressure, preforms from a thermoplastic material, for example preforms from PET (polyethylene terephthalate) within a blowing machine are supplied to various processing stations. A blowing machine of this type typically has a heating installation and a blowing installation, in the region of which the preform which prior thereto has been temperature controlled is expanded by way of biaxial orientation to form a container. Expansion is performed with the aid of compressed air which is directed into the preform to be expanded. The process-technological sequence of expanding the preform in such a manner is set forth in DE-OS 43 40 291.

The in-principle construction of a blowing station for molding containers is described in DE-OS 42 12 583. Possibilities for temperature controlling the preforms are set forth in DE-OS 23 52 926.

Within the blowing machine, the preforms and the blown containers may be conveyed with the aid of various handling installations. The use of conveying mandrels onto which the preforms are push-fitted has proven particularly successful. However, the preforms may also be handled using other carrier installations. The use of gripping tongs for handling preforms, and the use of expanding mandrels which for mounting are introducible into a mouth area of the preform, inter alia are likewise available constructions.

Handling containers using transfer wheels in an arrangement with the transfer wheel between a blowing wheel and a delivery section is described in DE-OS 199 06 438, for example.

Handling of the preforms as has already been set forth is performed, on the one hand, in the so-called dual-stage methods in which the preforms are initially manufactured in an injection-molding method, are thereafter temporarily stored and are only later conditioned in terms of temperature and blown to form a container. On the other hand, an application is performed in the so-called single-stage methods in which the preforms are suitably temperature controlled and subsequently blown immediately after having been manufactured by injection-molding technology and having sufficiently solidified.

In terms of the blowing stations used, various embodiments are known. In the case of blowing stations which are disposed on rotating conveying wheels, book-like unfolding capability of the mold carriers may often be encountered. However, it is also possible for mold carriers which are mutually displaceable or guided in another manner to be employed. In the case of locationally fixed blowing stations which are in particular suitable for receiving a plurality of cavities for container molding, plates which are disposed so as to be mutually parallel are typically used as mold carriers.

In terms of sterilizing preforms, various methods and devices which, however, all have method-specific disadvantages, are already known from the prior art, said disadvantages impeding reliable sterilization of the preforms at simultaneously high output rates.

Sterilizing hot preforms using a hot gaseous sterilization means is described in EP-A 1 086 019, for example. Separate treatment stations which are sequentially disposed are used; namely a first heating module, a sterilizing module, and a second heating module. Here, the temperature-related behavior of the preform during the sterilizing procedure and uncontrolled leakage of the sterilization means from the preform within the heating unit are disadvantageous. The risk of renewed infestation with germs, for example already in the second heating module, continues to exist.

A method in which a gaseous sterilization means is directed into a cold preform and condenses therein prior to heating is described in EP-A 1 896 245. Ensuring overall formation of condensate on the entire internal face of the preform is problematic here, since the hot sterilization means streaming in increases the internal wall temperature of the preform. Moreover, here too the sterilization means after evaporation in the region of the heating unit leaks in an uncontrolled manner from the perform within the heating unit. Renewed infestation with germs in the heating unit is likewise still an issue.

The arrangement of a sterilizing installation between a heating unit and the blowing module is described in WO 2010/020530 A1. In this method, the amount of sterilization means to be applied in the region of the blowing module is foreseeable only with great difficulty. Moreover, the amount of sterilization means being released into the environment is uncontrollable and corresponding contamination is not excluded.

The use of UV emitters for sterilizing tasks is generally known from DE 295 03 830 U1, for example. A space which is enclosed by a protective housing is to be de-germinated by radiation using UV light. This document does not disclose de-germinating preforms or containers or elements of a blowing machine that come into contact with said preforms or containers.

The document of the generic type DE 10 2008 038 143 A1 discloses that UV radiation emitters are employable for sterilizing the external wall of preforms.

DE 10 2007 017 938 B4 discloses the use of radiation emitters for sterilizing the internal surfaces of preforms. For this purpose, a sterilizing probe which carries a radiation emitter is introduced into the preform to be sterilized. WO2010/012915 A1 and EP 2 138 298 A2, in which for internally sterilizing a preform a radiation source is likewise introduced into the mouth of the preform, also show comparable prior art. It is stated in the last-mentioned document that a plurality of sterilizing installations are to be provided, namely at least one ahead of the installation in which the preforms are formed to containers, and at least one thereafter. It is seen to be disadvantageous in particular in the last-mentioned prior art that high complexity in terms of apparatuses is required.

A fundamental problem lies therein that it does not suffice to sterilize the preform per se. In order for renewed infestation with germs to be avoided, at least those elements of the blow-molding machine that come into contact with the preform after the latter has been sterilized have to be kept sterile. In the prior art, for example in EP 2 138 298 A2, this problem is addressed in that a sterile housing which surrounds the blow-molding machine and which is to be kept sterile with a significant effort is provided. The same document moreover proposes to perform a second sterilizing step after the blow-molding procedure. This also constitutes added significant constructive and energy-related complexity.

It is thus the object of the present invention to state a method by way of which sufficient sterility of the preforms may be guaranteed in a simple manner. A further object of the present invention is to state a respective device by way of which the method according to the invention is capable of being carried out.

These objects are achieved by a method as claimed in claim 1 and by a device as claimed in claim 11.

According to the method according to the invention, at least one radiation source for sterilizing radiation is disposed so as to be stationary in the heating installation and so as to be spaced apart from the preform, wherein the radiation direction of at least one of the at least one radiation source is aligned onto the mouth area of the preform and/or onto the carrier installation.

According to the device according to the invention, the radiation source for sterilizing radiation is disposed so as to be stationary in the heating installation and so as to be spaced apart from the preforms, wherein the radiation direction of at least one of the at least one radiation source is aligned onto the mouth area of the preform and/or onto the carrier installation.

Further advantageous design embodiments are stated in the dependent claims.

Problems relating to renewed infestation with germs primarily arise in the mouth area of the preform. In the oven which is used for temperature controlling the preforms, the main source for renewed infestation with germs is the carrier installation which carries the preform and guides the latter through the oven. Therefore, it is advantageous for sterilizing radiaion to be directed onto this area.

Reliable sterilizing of the carrier installation in particular is eminently important in order for renewed infestation by germs to be avoided. In the case of a heating installation (oven) in which carrier installations which revolve in an annular manner around deflection wheels guide the preform through the heating installation, and in which preforms in an infeed area are transferred to the heating installation and in a delivery area are removed from the heating installation, and in which the revolving carrier installations after removal of the preforms in the delivery area continue to run in a preform-less manner up to the infeed area around the head wheel, it is thus very advantageous that at least one radiation source is disposed in the area of the head wheel and is aligned onto the preform-less carrier installations. The carrier installations, for example conveying mandrels, which in this area are freely accessible, on account thereof may be impinged with and rendered germ-free by sterilizing radiation.

In the case of heating installations having a plurality of heating boxes which in the revolving direction of the preforms are disposed behind one another it is furthermore advantageous that at least one of the radiation sources is disposed within the heating boxes and/or is disposed between adjacent heating boxes. On account of the simultaneous action of sterilizing radiation and heating radiation, this in particular also contributes toward protecting the preform against infestation with germs.

The radiation source is preferably a linear emitter, the longitudinal axis thereof being aligned parallel with the longitudinal extent of the preforms moving past. A linear emitter here is understood to be an emitter which is elongate in one direction, that is to say is tubular, for example. On account thereof, impinging the preform along the entire longitudinal extent thereof with radiation is enabled. This is also achieved by a plurality of radiation sources in the direction of the longitudinal extent of the preforms moving past being disposed on top of one another. The radiation sources should emit onto mutually complementary height- related areas of the preform.

Sterile keeping or sterilizing the conveying installations, respectively, may still be improved in that at least that area of the heating installation in which the carrier installations revolve in a preform-less manner, is at least partially enclosed by a housing which is provided with a vacuum unit, and that the carrier installations within this housing are impinged with a chemical sterilizing means, in particular with hydrogen peroxide.

Further improvement is achievable in that in the case of interruptions of the blow-molding process (inline operation of the blowing machine) or in the case of a start-up of the blowing machine, the radiation sources continue to be active, so as to counter tendencies toward infestation with germs. During inline operation and during starting-up of the blowing machine the carrier installations continue to revolve, but without being supplied with preforms. Said carrier installations may be very well impinged with radiation in this state. Advantageously, this should be performed during at least one revolution of the carrier installations in the heating installation, so as to reliably irradiate each carrier installation or to reliably impinge the latter with the chemical sterilizing means in the housing-enclosed area.

It is also advantageous for further radiation sources which are directed onto the base area and/or onto the external side walls of the preform to be disposed in the heating installation. These areas are indeed less critical in terms of the product to be filled at a later stage. Nevertheless, sterilizing is also advantageous here.

More reliable and complete irradiation of the preforms is made possible in that a plurality of radiation sources are disposed around the preform in a circumferentially spaced-apart manner and are aligned onto the preform from various radial directions. The preform is encircled, so to speak, and is impinged with radiation from a plurality of directions; said preform is particularly advantageously impinged on the entire circumference thereof with radiation.

The same objective is served in that the carrier installation autorotates about the own axis thereof at least in areas while revolving in the heating installation, wherein the rotation axis is aligned so as to be parallel with the longitudinal extent of the preforms.

UV emitters may be used in a simple manner in terms of construction. Suitable UV emitters are known in the prior art, for example UV LEDs, low-pressure amalgam lamps, (low pressure, medium pressure, high pressure and maximum pressure) mercury vapor lamps, excimer lasers, and diode lasers.

Preferably, UV emitters which emit radiation which in particular is in a wavelength range which is suitable for sterilizing, for example in a range from 180 to 300 nm, either in a narrow band or in a wide band, are disposed as radiation sources. It is seen as being optimal for the radiation to be intense in the range of 220 nm and/or 265 nm.

The advantages which have been described above for the method according to the invention apply in an analogous manner to the devices according to the invention. The mentioned advantages may be achieved in particular with a heating installation and/or with heating boxes which are equipped with radiation sources, as has been previously described.

The invention is to be explained in more detail hereunder by means of exemplary embodiments. Exemplary embodiments of the invention are illustrated in a schematic manner in the drawings in which:

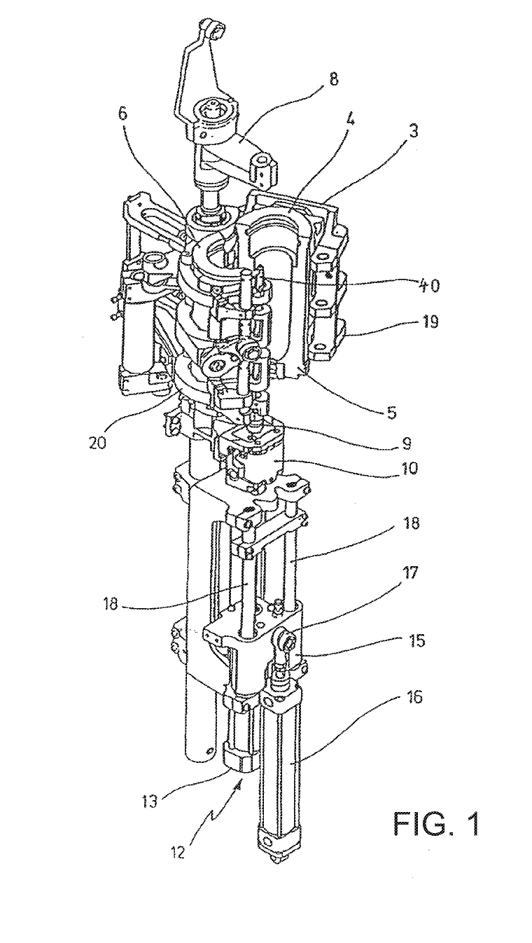

FIG. 1 shows a perspective illustration of a blowing station for manufacturing containers from preforms;

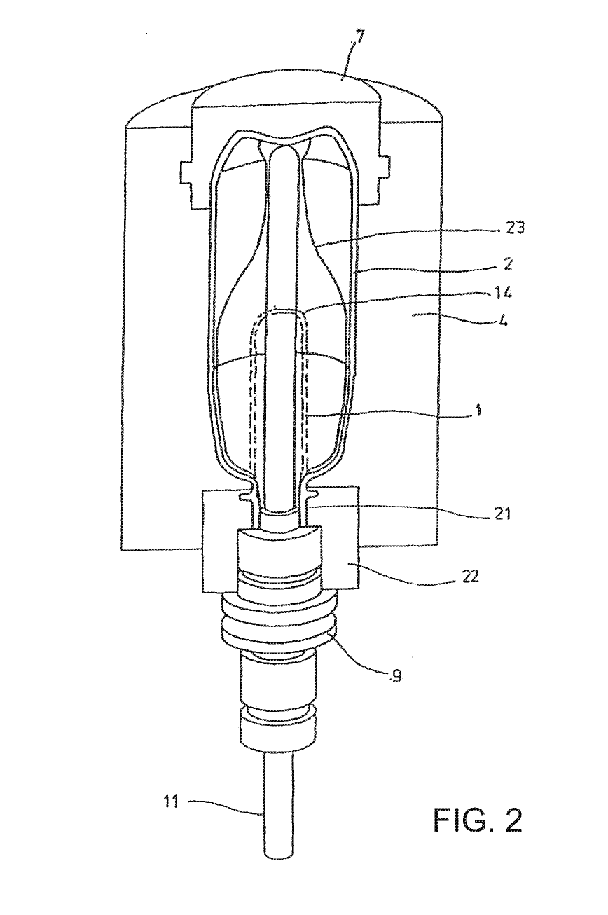

FIG. 2 shows a longitudinal section through a blow mold in which a preform is stretched and expanded;

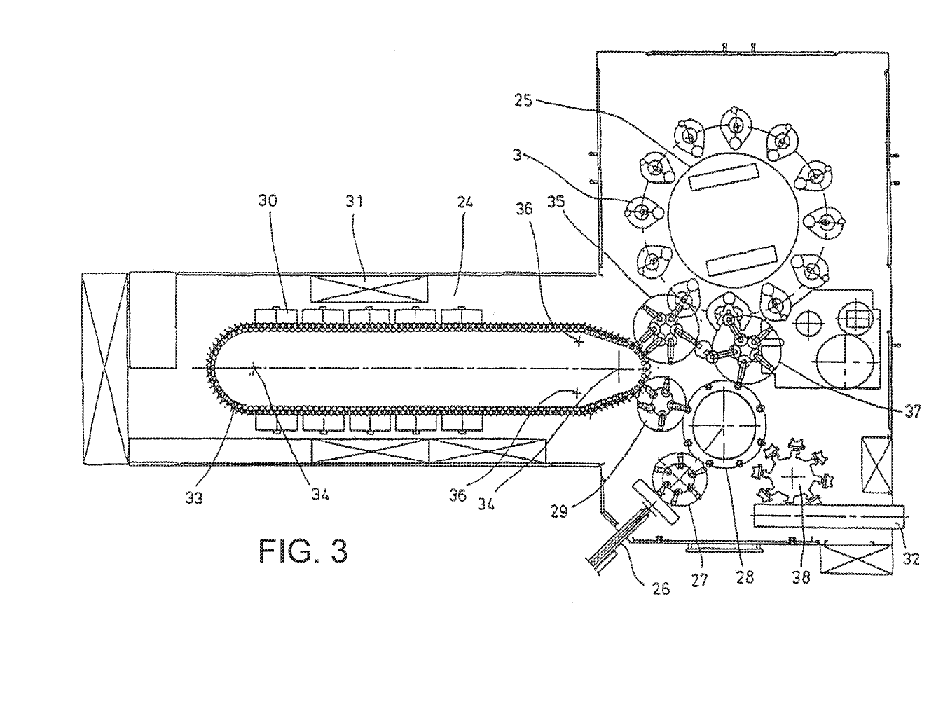

FIG. 3 shows a diagram to visualize an in-principle construction of a device for blow-molding containers;

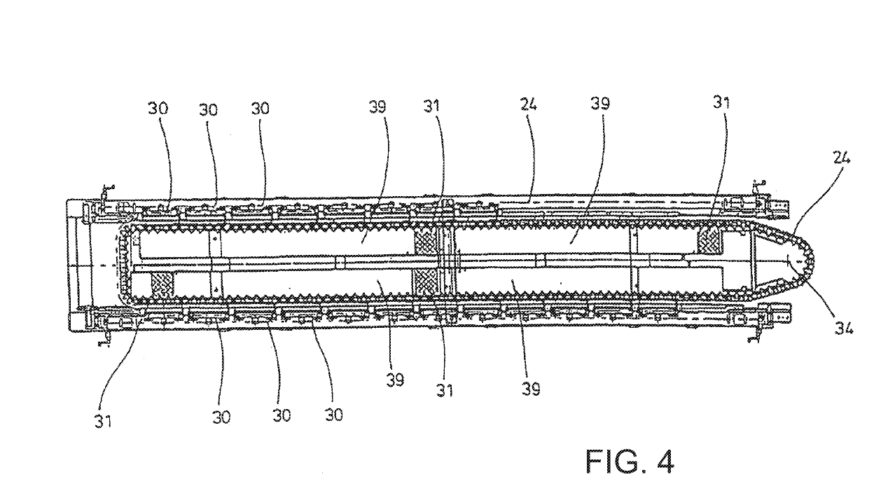

FIG. 4 shows a modified heating section having an increased heating capacity;

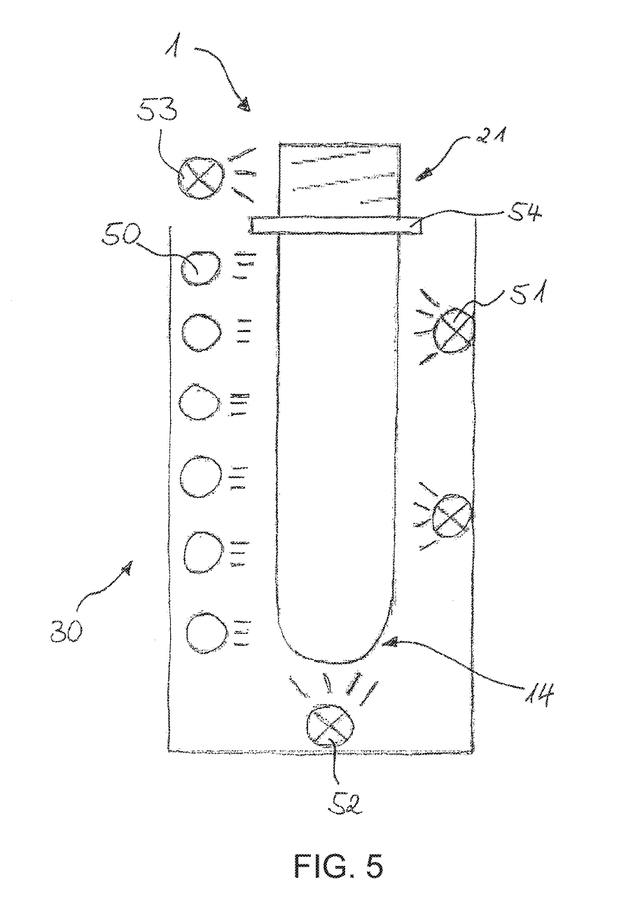

FIG. 5 shows a heating box with the preform disposed therein and with a plurality of radiation sources, in a schematic sectional illustration;

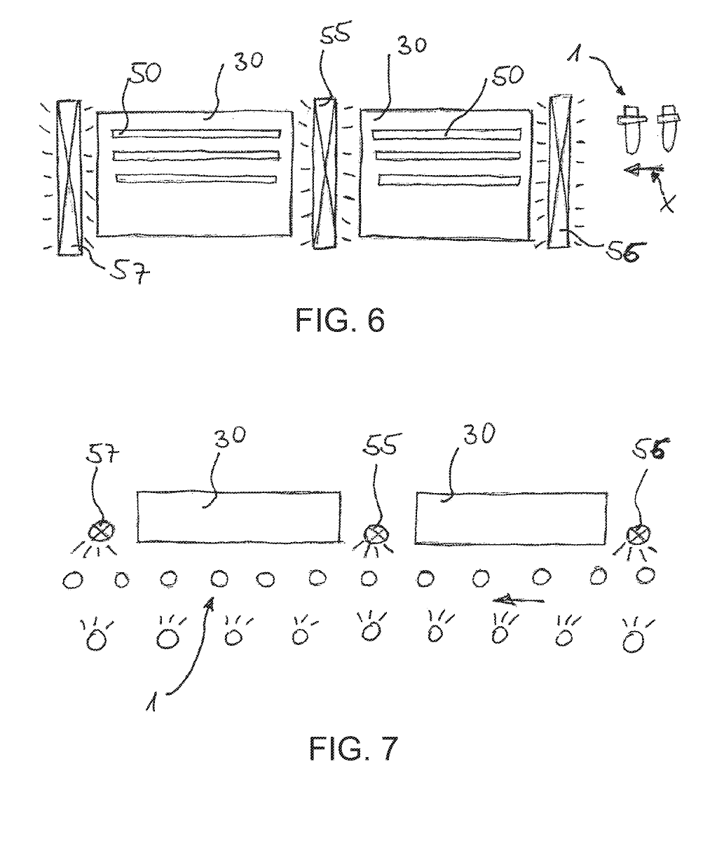

FIG. 6 shows a part-area of a heating section of a blowing machine, having radiation sources, in an in-principle lateral view;

FIG. 7 shows the part-area of the heating section which is illustrated in FIG. 6, in a view from above;

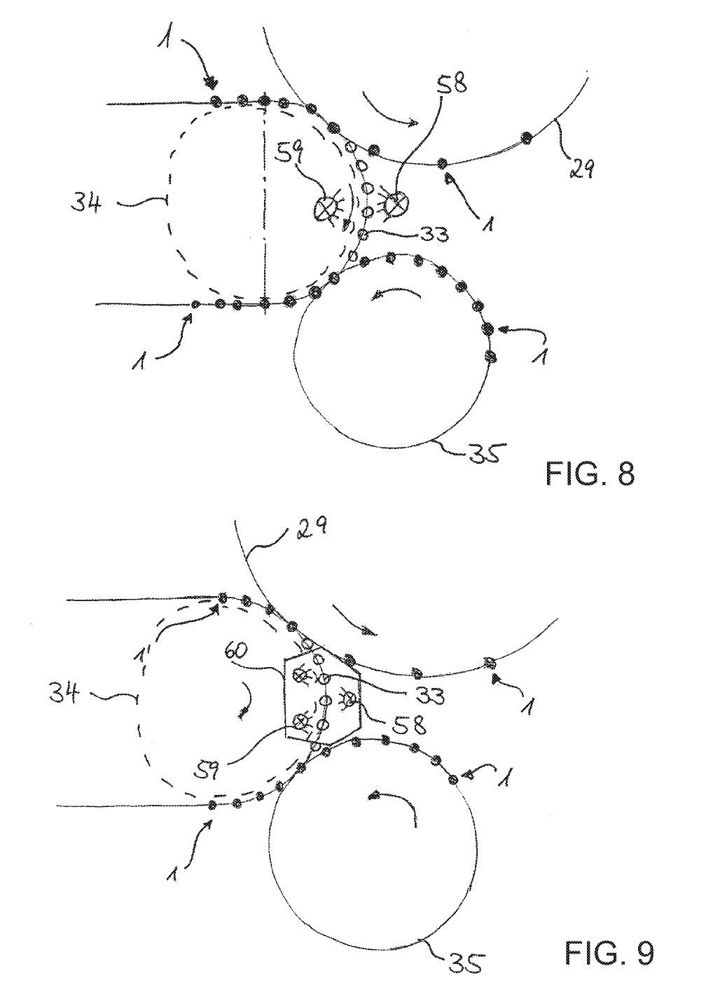

FIG. 8 shows the entry and exit area of a heating section according to the invention, having radiation sources, in an in-principle plan view; and

FIG. 9 shows the entry and exit area of a second exemplary embodiment of a heating section according to the invention, in an in-principle plan view which is analogous to FIG. 8.

The in-principle construction of a device for forming preforms 1 into containers 2 is illustrated in FIGS. 1 and 2.

The device for molding the container 2 (blowing machine) is substantially composed of a blowing station 3 which is provided with a blow mold 4 into which a preform 1 is insertable. The preform 1 may be an injection-molded part made from polyethylene terephthalate. In order to enable insertion of the preform 1 into the blow mold 4, and in order to enable removal of the finished container 2, the blow mold 4 is composed of two mold halves 5, 6, and of a base part 7 which is positionable by a lifting device 8. The preform 1 in the area of the blowing station 3 may be held by a conveying mandrel 9 which together with the preform 1 passes through a plurality of treatment stations within the device. However, it is also possible for the preform 1 to be inserted directly into the blow mold 4 for example by way of tongs or other handling means.

In order for a compressed-air supply line to be enabled, a connector piston 10 which supplies compressed air to the preform 1 and at the same time performs sealing toward the conveying mandrel 9 is disposed below the conveying mandrel 9. However, in the case of a modified construction it is also conceivable in principle that fixed compressed-air supply lines are used.

Stretching of the preform 1 is performed with the aid of a stretching rod 11 which is positioned by a cylinder 12. However, in principle it is also conceivable for mechanical positioning of the stretching rod 11 to be carried out by curved segments which are impinged by tracking rollers. The use of curved segments is expedient in particular when a plurality of blowing stations 3 are disposed on a rotating blowing wheel. Use of cylinders 12 is expedient when blowing stations 3 which are disposed in a locationally fixed manner are provided.

In the embodiment illustrated in FIG. 1 the stretching system is configured in such a manner that a tandem arrangement of two cylinders 12 is provided. Prior to commencement of the stretching procedure per se, the stretching rod 11 is initially moved by a primary cylinder 13 into the area of a base 14 of the preform 1. During the stretching procedure per se the primary cylinder 13 having the extended stretching rod, together with a slider 15 which supports the primary cylinder 13, is positioned by a secondary cylinder 16 or by way of a cam control unit. In particular, it is contemplated that the secondary cylinder 16 is employed in a cam-controlled manner such that a current stretching position is predefined by a guide roller 17 which slides along a curved track while the stretching procedure is carried out. The guide roller 17 is urged against the guide track by the secondary cylinder 16. The slider 15 slides along two guide elements 18.

After the mold halves 5, 6 which are disposed in the area of supports 19, 20 have been closed, mutual interlocking of the supports 19, 20 with the aid of an interlocking installation 40 is performed.

In order for a mouth portion 21 of the preform 1 to be adapted to various shapes, the use of separate threaded inserts 22 is provided according to FIG. 2 in the area of the blow mold 4.

In addition to the blown container 2, FIG. 2 also shows the preform 1 having dashed lines and in a schematic manner a container bubble 23 under formation.

FIG. 3 shows the in-principle construction of a blowing machine which is provided with a heating section 24 as well as a rotating blowing wheel 25. Proceeding from a preform infeed 26, the preforms 1 are conveyed into the area of the heating section 24 by transfer wheels 27, 28, 29. Heating radiators 30 and blowers 31 are disposed along the heating section 24, so as to temperature control the preforms 1. After sufficient temperature control of the preforms 1, the latter are transferred to the blowing wheel 25, the blowing stations 3 being disposed in the area thereof. The blown finished containers 2 are supplied to a delivery section 32 by further transfer wheels.

In order to be able to form a preform 1 into a container 2 in such a manner that the container 2 has material properties which guarantee a prolonged shelf life of foodstuffs, in particular beverages, which are filled into the container 2, special method steps must be adhered to when heating and orienting the preforms 1. Moreover, advantageous effects may be achieved by adhering to special dimensional rules.

Various plastics may be used for the thermoplastic material. PET, PEN, or PP are employable, for example.

Expanding the preform 1 during the orientation procedure is performed by supplying compressed air. The compressed air supply is subdivided into a pre-blowing phase in which gas, for example compressed air, is supplied at a low pressure level, and into a subsequent main blowing phase in which gas is supplied at a comparatively high pressure level. During the pre-blowing phase, compressed air at a pressure in the range of 10 bar to 25 bar is typically used, and during the main blowing phase, compressed air at a pressure in the range of 25 bar to 40 bar is supplied.

It can likewise be seen in FIG. 3 that the heating section 24 in the embodiment illustrated is configured by a plurality of revolving conveying elements 33 which are strung together in a chain-like fashion and are guided along deflection wheels 34. In particular, it is contemplated that a substantially rectangular basic contour is defined by the chain-like arrangement. In the case of the embodiment illustrated, a single deflection wheel 34 which is of comparatively large size is used in the area of that extent of the heating section 24 that faces the transfer wheel 29 and an infeed wheel 35, and two deflection wheels 36 which are of comparatively small size are used in the area of adjacent deflections. However, other guides are also conceivable in principle.

In order for as tight a mutual arrangement of the transfer wheel 29 and of the infeed wheel 35 as possible to be enabled, the arrangement illustrated has proven particularly expedient, since three deflection wheels 34, 36 are positioned in the area of the respective extent of the heating section 24, specifically in each case the comparatively small deflection wheels 36 in the area of the transition toward the linear profiles of the heating section 24, and the comparatively large deflection wheel 34 in the immediate transfer area to the transfer wheel 29 and to the infeed wheel 35. As an alternative to the use of chain-like conveying elements 33, it is also possible for a rotating heating wheel to be used, for example.

After blowing of the containers 2 has been completed, the latter are guided out of the area of the blowing stations 3 by a retrieval wheel 37 and by way of the transfer wheel 28 and of a delivery wheel 38 are conveyed to the delivery section 32.

On account of the higher number of heating radiators 30, a larger amount of preforms 1 per unit of time may be temperature controlled in the modified heating section 24 illustrated in FIG. 4. The blowers 31 here direct cooling air into the area of cooling air ducts 39 which in each case lie opposite the assigned heating radiators 30 and discharge the cooling air via outflow openings. On account of the arrangement of the outflow directions, a streaming direction for the cooling air that is substantially transverse to a conveying direction of the preforms 1 is implemented. The cooling air ducts 39 in the area of those surfaces that lie opposite the heating radiators 30 may provide reflectors for the radiation of heat; it is likewise possible for cooling of the heating radiators 30 to be implemented by way of the dissipated cooling air.

FIG. 5 shows a preform 1 in a sectional view, while passing through a heating box 30. This heating box on the one side thereof has an infrared emitter 50, so as to impinge the preform 1 with infrared radiation and to bring said preform 1 up to the temperature required for blow-molding. An example of such a heating box 30 is shown in DE 10 2009 057 021 A1, DE 10 2005 060 429 A1, or DE 10 2004 034 286 A1, for example. Furthermore, a plurality of UV emitters 51, 52, 53 are shown in FIG. 5. A base emitter 52 which illuminates the closed base 14 of the preform 1 with UV radiation is disposed to the base side of the preform 1, and sterilizes this base area 14 in this way. Two further UV emitters 51 which are aligned onto the preform 1 and impinge the external side wall of the latter with UV light are disposed at dissimilar heights of the preform 1, so as to be opposite the infrared emitters 50. More than two UV emitters 52 may also be disposed on top of one another, so as to achieve sufficient illumination with UV radiation along the entire length of the side wall of the preform 1. A linear emitter which replaces the lateral UV emitters 51 could also be provided.

Finally, a UV emitter 53 which is aligned onto the mouth region 21, and presently in particular onto the threaded area of the preform 1 above the neck ring 54, is disposed above the infrared emitter 50. This UV emitter 53 is tasked with sterilizing the mouth area 21 of the preform 1 from the outside.

FIG. 6, in an in-principle illustration, shows a front view of the part-area of a heating section 24 (oven). Two heating boxes 30 are illustrated, a first linear emitter 55 for illuminating preforms 1 with UV light being disposed therebetween. Further linear emitters 56, 57 are illustrated at either end of the illustrated fragment, still further (not illustrated) heating boxes typically adjoining thereto. As is illustrated by the arrow X, preforms 1 run past the sequenced arrangement composed of linear emitter 1 (56), heating box 1 (30), linear emitter 2 (55), heating box 2 (30), and linear emitter 3 (57). In the arrangement shown, the moving preform 1 is impinged in an alternating manner with UV light and infrared light. The infrared light serves for heating the preform 1, while the UV light serves for external sterilizing.

FIG. 7, in an in-principle illustration, shows the arrangement shown in FIG. 6 in a plan view. As is illustrated by the arrow X, preforms 1 are moved past the heating boxes 30 (shown) and the UV emitters (55, 56, 57 (shown). As is furthermore illustrated in FIG. 7, the preforms 1 may be impinged with UV light from a plurality of sides. This is of particular advantage in order for the preforms 1 to be illuminated with UV radiation in as seamless and area-covering manner over as long a period of time as possible. It is also possible for further UV emitters to be disposed on the infrared-emitter side of the heating box 30, as is indicated in FIG. 5.

FIGS. 8 and 9, in an in-principle plan view, show that portion of the heating section 24 in which the preforms 1 move in the area of the head wheel 34 and are transferred from an entry star wheel 35 to the heating section 24, and are delivered from the heating section 24 to an exit star wheel 29. UV emitters 58, 59 are disposed on mutually opposing sides in the interdisposed area. Once the preforms 1 have been delivered to the exit star wheel 29, the conveying mandrels 33 pass through this area which is impinged with UV light in a preformless manner. The UV emitters 58, 59 here are disposed and aligned such that they impinge the conveying mandrels 33, which are now freely accessible, with UV light. While the conveying mandrels 33 having the preforms 1 pass through the heating section 24, the former are typically set in autorotation about the longitudinal axis of the preform. This autorotation is preferably also continued in that area in which the conveying mandrels 33 without preforms 1 revolve from the exit star wheel 29 to the entry star wheel 35 around the head wheel 34, in order for the conveying mandrels 33 to be illuminated with UV radiation as far as possible on all sides and as uniformly intensively as possible.

In contrast to FIG. 8, this transition area between the exit star wheel 35 and the entry star wheel 29 in FIG. 9 is encapsulated by means of a housing 60. Installations (not illustrated) are provided within the housing 60, in order for hydrogen peroxide to be applied to the preform-less conveying mandrel 33. These installations may be spraying nozzles, for example, which spray hydrogen peroxide onto the conveying mandrels 33. The housing 60 is preferably equipped with a vacuum device which suctions evaporated hydrogen peroxide.

1.-22. (canceled)

23. A method for producing in a blowing machine blow-molded containers which are sterile in at least some areas, the method comprising the steps of: initially guiding a preform of a thermoplastic material by a carrier installation through a heating installation and heating the preform in the heating installation; impinging the preform with a pressurized fluid; and impinging the preform with sterilizing radiation at least in some areas; disposing at least one radiation source for sterilizing radiation so as to be stationary in the heating installation and so as to be spaced apart from the preform; and aligning a radiation direction of at least one of the at least one radiation source onto a mouth area of the preform and/or onto the carrier installation.

24. The method as claimed in claim 23, wherein the carrier installations revolve in an annular manner around deflection wheels, and preforms in an infeed area are transferred to the heating installation and in a delivery area are removed from the heating installation, wherein the revolving carrier installations after removal of the preforms in the delivery area continue to run without preforms up to the infeed area around a head wheel, wherein at least one radiation source is disposed in an area of the head wheel and is aligned onto the preform-less carrier installations which are configured as mandrels.

25. The method as claimed in claim 24, wherein the heating installation has a plurality of heating boxes which in a revolving direction of the preforms are disposed behind one another, wherein at least one of the radiation sources is disposed within the heating boxes and/or is disposed between adjacent heating boxes.

26. The method as claimed in claim 23, wherein the radiation source is a linear emitter having a longitudinal axis aligned parallel with a longitudinal extent of the preforms moving past.

27. The method as claimed in claim 23, wherein a plurality of radiation sources are disposed on top of one another in a direction of a longitudinal extent of the preforms moving past.

28. The method as claimed in claim 24, wherein at least an area of the heating installation in which the carrier installations revolve without preforms is at least partially enclosed by a housing that is provided with a vacuum unit, and the carrier installations within the housing are impinged with a chemical sterilizing agent.

29. The method as claimed in claim 28, wherein the chemical sterilizing agent is hydrogen peroxide.

30. The method as claimed in claim 28, wherein during a start-up of the heating installation or of the blow-molding installation, and/during inline operation of the heating installation or of the blow-molding installation, the radiation sources continue to emit radiation during at least one revolution of the carrier installations in the heating installation and/or in the housing-enclosed area the carrier installations continue to be impinged with the chemical sterilizing agent for at least one revolution.

31. The method as claimed in claim 23, including disposing further radiation sources, which are directed onto a base area and/or onto external side walls of the preform, in the heating installation.

32. The method as claimed in claim 23, including disposing a plurality of radiation sources around the preform in a circumferentially spaced-apart manner and aligning the radiation sources onto the preform from various radial directions.

33. The method as claimed in claim 23, wherein the carrier installation autorotates about an axis at least in areas while revolving in the heating installation, wherein the rotation axis is aligned so as to be parallel with a longitudinal extent of the preforms.

34. The method as claimed in claim 23, wherein the radiation sources are UV emitters.

35. A blowing machine for producing blow-molded containers which are sterile in at least some areas, the blowing machine comprising: a sterilizing installation having at least one radiation source for impinging at least part of a preform with sterilizing radiation; a heating installation for temperature controlling the preforms at a blow-molding temperature; a blowing installation for blow-molding the preforms to form the containers; and carrier installations that guide the preforms through the heating installation, wherein the radiation source for sterilizing radiation is stationary in the heating installation and spaced apart from the preforms, wherein a radiation direction of at least one of the at least one radiation source is aligned onto a mouth area of the preform and/or onto the carrier installation.

36. The blowing machine as claimed in claim 35, wherein the carrier installations are operatively arranged to revolve in an annular manner around deflection wheels so that preforms in an infeed area are transferred to the heating installation and in a delivery area are removed from the heating installation, wherein the revolving carrier installations after removal of the preforms in the delivery area continue to run without preforms up to the infeed area around a head wheel, wherein at least one radiation source is disposed in an area of the head wheel and is aligned onto the preform-less carrier installations.

37. The blowing machine as claimed in claim 36, wherein the carrier installations are configured as mandrels.

38. The blowing machine as claimed in claim 36, wherein the heating installation has a plurality of heating boxes which in the revolving direction of the preforms are disposed behind one another, wherein at least one of the radiation sources is disposed within the heating boxes and/or is disposed between adjacent heating boxes.

39. The blowing machine as claimed in claim 35, wherein the radiation source is a linear emitter having a longitudinal axis aligned parallel with a longitudinal extent of the preforms moving past.

40. The blowing machine as claimed in claim 35, wherein a plurality of radiation sources are disposed on top of one another in a direction of a longitudinal extent of the preforms moving past.

41. The blowing machine as claimed in claim 36, wherein at least an area of the heating installation in which the carrier installations revolve without the preforms is at least partially enclosed by a housing that is provided with a vacuum unit, and sterilizing installations are arranged within the housing so as to impinge a chemical sterilizing agent on the carrier installations in the housing.

42. The blowing machine as claimed in claim 41, wherein during a start-up of the heating installation and/or during inline operation of the heating installation the radiation sources are operative to continue to emit radiation and/or in the housing-enclosed area the carrier installations continue to be impinged with the chemical sterilizing agent for at least one revolution of the carrier installations in the heating installation.

43. The blowing machine as claimed in claim 35, further comprising further radiation sources disposed in the heating installation and directed onto a base area and/or onto a external side walls of the preform.

44. The blowing machine as claimed in claim 35, wherein a plurality of radiation sources are disposed around the preform in a circumferentially spaced-apart manner and are aligned onto the preform from various radial directions.

45. The blowing machine as claimed in claim 36, wherein the carrier installation is configured so as to autorotate about an axis at least in areas while revolving in the heating installation, wherein the rotation axis is aligned so as to be parallel with a longitudinal extent of the preforms.

46. The blowing machine as claimed in claim 5 wherein the radiation sources are configured as UV emitters.

47. A heating installation, comprising:
carrier installations that guide the preforms; and
a radiation source for impinging at least part of a preform with sterilizing radiation, the radiation source being stationary and spaced apart from the preforms, wherein a radiation direction of the radiation source is aligned onto a mouth area of the preform and/or onto the carrier installation.

48. A heating box, comprising:
carrier installations operatively arranged to revolve in an annular manner around deflection wheels so that preforms in an infeed area are transferrable to the heating box and in a delivery area are removable from the heating box, wherein the revolving carrier installations after removal of the preforms in the delivery area continue to run without preforms up to the infeed area around a head wheel; and
at least one radiation source for sterilizing radiation.
